(19) United States
(12) Patent Application Publication
(10) Pub. No.: US 2017/0134462 A1
(43) Pub. Date: May 11, 2017

(54) MOBILE TERMINAL AND MULTIMEDIA DATA SENDING METHOD BASED ON SAME

(71) Applicants: LE HOLDINGS (BEIJING) CO., LTD., Beijing (CN); Lemobile information Technology (Beijing) Co., Ltd, Beijing (CN)

(72) Inventor: Yan YU, Beijing (CN)

(21) Appl. No.: 15/247,752

(22) Filed: Aug. 25, 2016

Related U.S. Application Data
(63) Continuation of application No. PCT/CN2016/088542, filed on Jul. 5, 2016.

(30) Foreign Application Priority Data
Nov. 6, 2015 (CN) 201510757791.7

(51) Int. Cl. H04L 29/06; H04W 4/20

(52) U.S. Cl. CPC H04L 65/601; H04W 4/20

(57) ABSTRACT

An embodiment of the present disclosure discloses a mobile terminal and a multimedia data sending method based on the same. The mobile terminal at least includes a MHL interface, a WiHD linkage unit and a Miracast linkage unit; and the method includes: when detecting a trigger operation of a user for multimedia data currently displayed by the mobile terminal, deciding a target linkage unit from the MHL interface and/or the WiHD linkage unit and/or the Miracast linkage unit; sending the multimedia data to a display device by employing the target linkage unit, wherein the display device is configured to display the multimedia data. The embodiment of the present disclosure can enable a user to obtain an optimal protection screen effect under a current network environment, and improve a user experience.

### CROSS-REFERENCE TO RELATED APPLICATIONS

This application is a continuation of International Application No. PCT/CN2016/088542, filed on Jul. 5, 2016, which is based upon and claims priority to Chinese Patent Application No. 201510757791.7, filed on Nov. 6, 2015, the entire contents of which are incorporated herein by reference.

### TECHNICAL FIELD

An embodiment of the present disclosure generally relates to the field of multimedia technologies, and particularly relates to a mobile terminal and a multimedia data sending method based on the same.

### BACKGROUND

As the processing capacity and the decoding capacity of a mobile terminal become stronger, more and more mobile terminals have their own high-definition output functions. At present, main high-definition outputs may include wire transmission technologies such as HDMI (High Definition Multimedia Interface), MHL (Mobile High-Definition Link) and SlimPort (Analogix Semiconductor) as well as wireless transmission technologies such as DLNA (Digital Home Working Group), Miracast (a Miracast device provides simplified findings and settings, a user may rapidly transmit a video among devices), WiHD (WirelessHD) or Airplay.

However, in a practical application, since a high-definition output technology in the mobile terminal mismatches the picture source quality of video quality, video is easily hindered, resulting in relatively poor user experience and low operating frequency of high-definition output.

### SUMMARY

An embodiment of the present disclosure discloses a a mobile terminal and a multimedia data sending method based on the same, which are used for solving the problems of relatively poor user experience and low operating frequency of high-definition output resulting from hindering of video easily caused by mismatching of a high-frequency output technology in a mobile terminal and the picture source quality of video data in the prior art.

According to one aspect of the present disclosure, an embodiment of the present disclosure provides a multimedia data sending method based on a mobile terminal, the mobile terminal at least includes a MHL interface, a WiHD linkage unit and a Miracast linkage unit; and the method includes:

when detecting a trigger operation of a user for multimedia data currently displayed by the mobile terminal, deciding a target linkage unit from the MHL interface and/or the WiHD linkage unit and/or the Miracast linkage unit;

sending the multimedia data to a display device by employing the target linkage unit, wherein the display device is configured to display the multimedia data.

According to another aspect of the present disclosure, an embodiment of the present disclosure further provides a mobile terminal for sending multimedia data, the mobile terminal at least includes a MHL interface, a WiHD linkage unit and a Miracast linkage unit; the mobile terminal further includes: at least one processor, and a memory communicably connected with the at least one processor for storing instructions executable by the at least one processor, wherein execution of the instructions by the at least one processor causes the at least one processor to:

when detecting a trigger operation of a user for multimedia data currently displayed by the mobile terminal, decide a target linkage unit from the MHL interface and/or the WiHD linkage unit and/or the Miracast linkage unit;

send the multimedia data to a display device by employing the target linkage unit, wherein the display device is configured to display the multimedia data.

According to yet another aspect of the present disclosure, a computer program is provided, which includes a computer readable code, and when the computer readable code is executed on a mobile terminal, the computer program causes the mobile terminal to perform the above multimedia data sending method based on a mobile terminal.

According to still another aspect of the present disclosure, a non-transitory computer readable medium is provided, which stores executable instructions that, when executed by a mobile terminal, cause the mobile terminal to: when detecting a trigger operation of a user for multimedia data currently displayed by the mobile terminal, decide a target linkage unit from the MHL interface and/or the WiHD linkage unit and/or the Miracast linkage unit; send the multimedia data to a display device by employing the target linkage unit, wherein the display device is configured to display the multimedia data.

The present disclosure has the advantageous effects:

in the embodiments of the present disclosure, three projection screen technologies such as the MHL interface, the WiHD linkage unit and the Miracast linkage unit co-exist in the mobile terminal, and an optimal projection screen technology is decided from the three projection screen technologies according to an actual condition so as to adapt to demands of a user for interconnection and transmission screens between the mobile terminal and the display device. Different qualities of videos may be pushed among a plurality of devices, and multimedia contents are shared, and thereby a multi-screen interaction function is achieved, the user can obtain an optimal projection screen effect under a current network environment, and a user experience is improved.

The foregoing illustration is only an overview of a technical solution of the present disclosure. A technical means of the present disclosure can be more fully practiced in accordance with the description, and the above and other objects, features and advantages of the present invention will be more clearly understood from the following detailed description.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow diagram of steps of an embodiment of a multimedia data sending method based on a mobile terminal according to an embodiment of the present disclosure.

FIG. 2 is a block diagram of a structure of an embodiment of a mobile terminal for sending multimedia data according to an embodiment of the present disclosure.

FIG. 3 schematically shows a block diagram of a mobile terminal for performing a method according to the present disclosure.

FIG. 4 schematically shows a storage unit for holding or carrying a program code of implementing the method according to the present disclosure.

### DETAILED DESCRIPTION

For the purpose of making objects, technical schemes and advantages of an embodiment of the present disclosure more clear, clear and complete description will be made to technical schemes of the present disclosure in conjunction with corresponding drawings in the embodiment of the present disclosure. Obviously, the described embodiments are merely a part of the embodiments of the present disclosure and not all the embodiments. Based on the embodiments of the present disclosure, all other embodiments obtained by those ordinarily skilled in the art without investing creativity fall within the protection scope of the present disclosure.

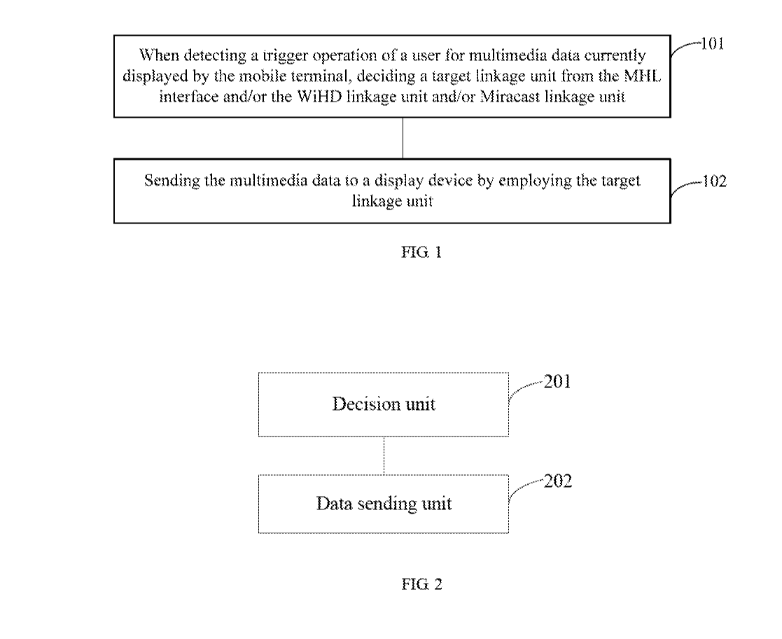

With reference FIG. 1, a flow diagram of steps of an embodiment of a multimedia data sending method based on a mobile terminal according to an embodiment of the present disclosure is shown. Wherein the mobile terminal of the embodiment of the present disclosure may at least include a MHL interface, a WiHD linkage unit and a Miracast linkage unit, wherein:

the MHL interface corresponds to a MHL technology, the MHL interface on the mobile terminal is connected onto a display device by a MHL dongle of a multiplexing USB interface, thereby realizing video sharing and supporting transmission of an uncompressed high-definition video stream. The embodiment of the present disclosure may preferably employ a MHL3.0 technology, and a theoretical transmission rate of the MHL3.0 may reach 6 Gbps.

The WiHD linkage unit corresponds to a WiHD technology, the WiHD is a high-speed wireless technology, which applies a frequency spectrum of a 60 GHz frequency band (millimeter waves), and can obtain a relatively high data transmission rate, with its initial transmission rate reaching up to 4 Gbps, thereby being capable of more relatively providing a bandwidth necessary to transmit a high-quality and high-definition uncompressed video. The embodiment of the present disclosure preferably employs WiHD1.1.

The Miracast linkage unit corresponds to a Miracast technology, the Miracast is a protocol definition from Wi-Fi Alliance, a Miracast device provides simplified findings and settings by a Wi-Fi Direct (a Wi-Fi Direct standard means that devices in a wireless network are allowed to be mutually connected without a wireless router, and is similar to a Bluetooth technology, and such a standard allows wireless devices to be mutually connected in a peer-to-peer manner, and is greatly improved in terms of a transmission speed and a transmission distance in comparison with the Bluetooth technology) technology, and therefore the user may rapidly transmit a compressed video movement among the devices.

The embodiment of the present disclosure may include the steps as follows.

Step 101. When detecting a trigger operation of a user for multimedia data currently displayed by the mobile terminal, deciding a target linkage unit from the MHL interface and/or the WiHD linkage unit and/or the Miracast linkage unit.

In the embodiment of the present disclosure, projection screen technologies such as the MHL interface, the WiHD linkage unit and the Miracast linkage unit may be integrated in one mobile terminal, however, for the sake of limitation to the processing capacity of the mobile terminal and power consumption, when detecting a trigger operation of a user for multimedia data currently displayed by the mobile terminal, it only supports one projection screen technology at the same moment, and may switch among different projection screen technologies.

In one preferred embodiment of the embodiments of the present invention, the step 101 may include the following substeps:

substep S11. when detecting a trigger operation of a user for multimedia data currently displayed by the mobile terminal, respectively acquiring decision parameter information corresponding to the MHL interface, the WiHD linkage unit or the Miracast linkage unit;

substep S12. deciding a target linkage unit from the MHL interface, the WiHD linkage unit or the Miracast linkage unit in accordance with the decision parameter information.

By applying the embodiment of the present disclosure, the target linkage unit may be decided according to the decision parameter information corresponding to the MHL interface, the WiHD linkage unit or the Miracast linkage unit when the trigger operation of the user for the multimedia data currently displayed by the mobile terminal is detected.

As one example, the decision parameter information at least includes bandwidth and transmission rate parameters, a delay parameter, a power consumption parameter, a safety parameter, a quality parameter of the multimedia data, a flow performance and a signal stability of WIFI under a prevailing circumstance.

Particularly, when the three projection screen technologies of the MHL interface, the WiHD linkage unit and the Miracast linkage unit co-exist in the mobile terminal, an optimal projection screen technology may be selected according to the following several decision parameter information, so as to reduce a probability of hindering play of a video and improve a user experience.

Performance (Bandwidth and Rate)

In accordance with a specification, the theoretical performance of MHL3.0 may reach 6 Gbps, that is, the MHL may transmit a 4 K multimedia data source in a case where multimedia data is not compressed; existing WiHD1.1 supports 4 Gbps transmission so as to only transmit a 1 K multimedia data source; a bandwidth of Miracast is limited to the specification of the WIFI, the maximal theoretical performance of existing 802.11g is 54 Mbps, and the actual rate of generally-applied 802.11n is about 150 Mbps.

Further, with respect to wireless transmission, signal interference also influences the performance.

Accordingly, in terms of the performance, the MHL has a certain advantages in comparison with two wireless transmission screen technologies.

(2) Delay

The delay used herein refers to a time difference between displaying one image by a source terminal (mobile terminal) and mirroring the image to a display device (that is, a gateway node sink). The delay of the MHL in this respect may reach less than 1 ms of delay, the delay of WiHD is less than 2 ms; the Miracast has no the maximal delay time value verified at present.

(3) Power Consumption

For the mobile terminal, the endurance and the consumption of a battery are always more sensitive, power consumptions of the three projection technologies are as follows: because the MHL is a multiplexing USB interface, it may provide a charging function of maximal 5 V and 900 mA to the mobile terminal through a VBUS, such a charging quantity is sufficient to provide power consumed in a projection screen process. Other two wireless technologies do not have this advantage; and since the WiHD transmits data on a high-frequency band, the WiHD consumes more power than the Miracast in terms of power consumption.

(4) Safety

Three projection screen technologies all support a HDCP (High-bandwidth Digital Content Protection) technology.

(5) Flow Performance and Signal Stability of WIFI Under a Prevailing Circumstance

The flow performance and the signal stability of the WIFI under the prevailing circumstance may be obtained through a QoS mechanism of the WIFI in a system of the mobile terminal.

(6) Signal Interference Detection of WiHD

In a specific implementation, signal interference detection of the WiHD may be performed by, for example, an algorithm of automatically detecting that a WiHD wireless data projection channel is obstructed. Particularly, a WiHD wireless data channel is directly established between the WiHD and a dongle, but the wireless data channel substantially has no diffraction function depending on a 60 GHZ wireless spectrum characteristic, and data transmission of the wireless data channel easily fails due to obstruction of an object.

Due to consistency and peer-to-peer equality 60 Ghz peer-to-peer data transmission, although a WiHD device can not directly detect whether data emitted by it arrives at the dongle, whether a current wireless data channel is smooth or not may be derived through detecting a signal of the dongle, and if the signal of the dongle cannot be received at a certain moment, a prompt that a signal of the WiHD is poor may be provided to the user.

(7) Picture Source Quality of Play

If the picture source quality is 4 k, it may be transmitted after coding of MHL3.0.

Based on a consideration of the above decision parameter information, the following decision result may be obtained: In one preferred embodiment of the embodiments of the present disclosure, the substep S12 may further include the following substeps:

substep S21. when detecting a trigger operation of a user for multimedia data currently displayed by the mobile terminal, determining whether an access device accesses to the MHL interface or not:

substep S22. if the access device accesses to the MHL interface, using the MHL interface as a target linkage unit;

substep S23. if no access device accesses to the MHL interface, determining whether a quality parameter of the multimedia data is smaller than a first preset threshold or not and a signal intensity of the WiHD linkage unit is greater than a second preset threshold or not;

substep S24. if the quality parameter of the multimedia data is greater than the first preset threshold and the signal intensity of the WiHD linkage unit is greater than the second preset threshold, using the WiHD linkage unit as the target linkage unit;

substep S25. if the quality parameter of the multimedia data is smaller than the first preset threshold and the signal intensity of the WiHD linkage unit is smaller than the second preset threshold, using the Miracast linkage unit as the target linkage unit.

Particularly, based on overall consideration of the decision parameter information of the above individual aspect and estimation of a base layer on individual projection screen technologies, the following mechanism may be employed on an upper layer UI (User Interface) to recommend a user to apply which projection screen technology:

In a case where the MHL dongle exists, it may firstly recommend the user to use such a projection screen technology.

If no MHL dongle exists, as for two wireless technologies of Miracast and WiHD, if a picture source of multimedia data is 1 K and the signal quality of the WiHD is good, a WiHD projection screen technology may be preferably selected so as to ensure an optimal state of a projection screen effect. If only Miracast may be used, a Miracast projection screen technology is selected.

Step 102. Sending the multimedia data to a display device by employing the target linkage unit, wherein the display device is configured to display the multimedia data.

In one preferred embodiment of the embodiments of the present disclosure, the step 102 may include the following substeps:

substep S32. establishing a linkage channel between the mobile terminal and the display device by employing the target linkage unit;

substep S33. acquiring multimedia data the picture source quality of which adapts to the target linkage unit;

substep S34. sending the adapted multimedia data to the display device through the linkage channel.

For example, if the decided projection screen technology is Miracast, multimedia data of corresponding picture source quality may be pushed to a user in combination with flow performance and signal stability of current WIFI, and displayed on a display device by a Miracast projection screen.

In the embodiment of the present disclosure, three projection screen technologies such as the MHL interface, the WiHD linkage unit and the Miracast linkage unit co-exist in the mobile terminal, and an optimal projection screen technology is decided from the three projection screen technologies according to an actual condition so as to adapt to demands of a user for interconnection and transmission screens between the mobile terminal and the display device. Different qualities of videos may be pushed among a plurality of devices, and multimedia contents are shared, and thereby a multi-screen interaction function is achieved, the user can obtain an optimal projection screen effect under a current network environment.

With reference FIG. 2, a block diagram of a structure of an embodiment of a mobile terminal for sending multimedia data according to an embodiment of the present disclosure is shown, wherein the mobile terminal may at least include a MHL interface (not shown in FIG. 2), a WiHD linkage unit (not shown in FIG. 2) and a Miracast linkage unit (not shown in FIG. 2); the mobile terminal may further include:

a decision unit 201, which is configured to, when detecting a trigger operation of a user for multimedia data currently displayed by the mobile terminal, decide a target linkage unit from the MHL interface and/or the WiHD linkage unit and/or the Miracast linkage unit;

a data sending unit 202, which is configured to send the multimedia data to a display device by employing the target linkage unit, wherein the display device is configured to display the multimedia data.

In one preferred embodiment of the embodiments of the present disclosure, the decision unit 201 may include the following subunits:

a decision parameter information acquisition subunit, which is configured to, when detecting a trigger operation of a user for multimedia data currently displayed by the mobile terminal, respectively acquire decision parameter information corresponding to the MHL interface, the WiHD linkage unit and the Miracast linkage unit;

a decision subunit, which is configured to decide a target linkage unit from the MHL interface, the WiHD linkage unit and the Miracast linkage unit in accordance with the decision parameter information.

In one preferred embodiment of the embodiments of the present disclosure, the decision parameter information at least includes bandwidth and transmission rate parameters, a delay parameter, a power consumption parameter, a safety parameter, a quality parameter of the multimedia data, a flow performance and a signal stability of WIFI under a prevailing circumstance.

In one preferred embodiment of the embodiments of the present disclosure, the decision subunit may be configured to:

when detecting a trigger operation of a user for multimedia data currently displayed by the mobile terminal, determine whether an access device accesses to the MHL interface or not;

if the access device accesses to the MHL interface, use the MHL interface as a target linkage unit;

if no access device accesses to the MHL interface, determine whether a quality parameter of the multimedia data is smaller than a first preset threshold or not and a signal intensity of the WiHD linkage unit is greater than a second preset threshold or not;

if the quality parameter of the multimedia data is greater than the first preset threshold and the signal intensity of the WiHD linkage unit is greater than the second preset threshold, use the WiHD linkage unit as the target linkage unit;

if the quality parameter of the multimedia data is smaller than the first preset threshold and the signal intensity of the WiHD linkage unit is smaller than the second preset threshold, use the Miracast linkage unit as the target linkage unit.

In one preferred embodiment of the embodiments of the present disclosure, the data sending unit 202 may include the following subunits:

a channel establishing subunit, which is configured to establish a linkage channel between the mobile terminal and the display device by employing the target linkage unit;

a data adaptation subunit, which is configured to acquire multimedia data the picture source quality of which adapts to the target linkage unit;

a sending subunit, which is configured to send the adapted multimedia data to the display device through the linkage channel.

For the embodiment of the terminal of FIG. 2, since it is substantially similar to the embodiment of the above method, it is more simply described, and relevant parts refer to the partial description of the embodiment of the method.

Client or server embodiments described above are illustrative only, wherein the unit described as a separate part may be or may be not physically separated, a part displayed as the unit may be or may be not a physical unit, may be located in one place, or may be distributed on a plurality of network units. Some or all of the modules may be selected to achieve the objective of the solutions of the embodiments according to actual requirements. Those ordinarily skilled in the art may understand and implement it without paying creative works.

Each of devices according to the embodiments of the disclosure can be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the modules in the device according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the internet websites, or be provided in carrier, or be provided in other manners.

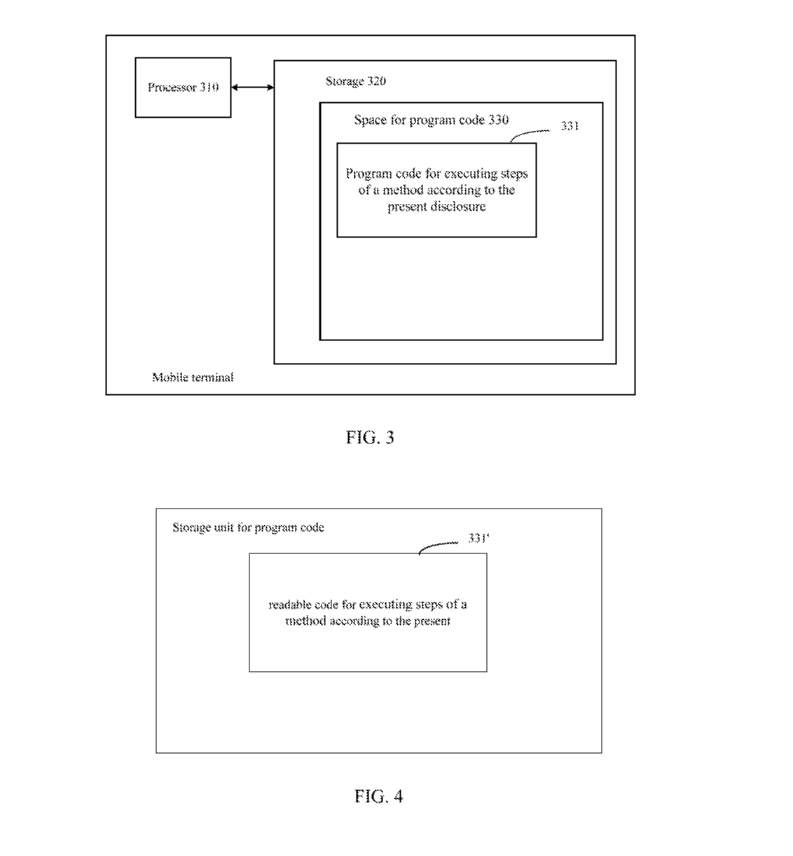

For example, FIG. 3 illustrates a block diagram of a mobile terminal for executing the method according the disclosure. Traditionally, the mobile terminal includes a processor 310 and a computer program product or a computer readable medium in form of a memory 320. The memory 320 could be electronic memories such as flash memory, EEPROM (Electrically Erasable Programmable Read—Only Memory), EPROM, hard disk or ROM. The memory 320 has a memory space 330 for executing program codes 331 of any steps in the above methods. For example, the memory space 330 for program codes may include respective program codes 331 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 4. The memory cells may be provided with memory sections, memory spaces, etc., similar to the memory 320 of the server as shown in FIG. 3. The program codes may be compressed for example in an appropriate form. Usually, the memory cell includes computer readable codes 331′ which can be read for example by processors 310. When these codes are operated on the server, the server may execute respective steps in the method as described above.

The “an embodiment”, “embodiments” or “one or more embodiments” mentioned in the disclosure means that the specific features, structures or performances described in combination with the embodiment(s) would be included in at least one embodiment of the disclosure. Moreover, it should be noted that, the wording “in an embodiment” herein may not necessarily refer to the same embodiment.

Many details are discussed in the specification provided herein. However, it should be understood that the embodiments of the disclosure can be implemented without these specific details. In some examples, the well-known methods, structures and technologies are not shown in detail so as to avoid an unclear understanding of the description.

It should be noted that the above-described embodiments are intended to illustrate but not to limit the disclosure, and alternative embodiments can be devised by the person skilled in the art without departing from the scope of claims as appended. In the claims, any reference symbols between brackets form no limit of the claims. The wording “include” does not exclude the presence of elements or steps not listed in a claim. The wording “a” or “an” in front of an element does not exclude the presence of a plurality of such elements. The disclosure may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings can be interpreted as a name.

Also, it should be noticed that the language used in the present specification is chosen for the purpose of readability and teaching, rather than explaining or defining the subject matter of the disclosure. Therefore, it is obvious for an ordinary skilled person in the art that modifications and variations could be made without departing from the scope and spirit of the claims as appended. For the scope of the disclosure, the publication of the inventive disclosure is illustrative rather than restrictive, and the scope of the disclosure is defined by the appended claims.

Finally, it should be noted that the foregoing embodiments are merely illustrative of technical solutions of the present disclosure without limitation; although the present disclosure is illustrated in detail with reference to the above embodiments, those ordinarily skilled in the art will appreciate that modifications may be made on the technical solutions cited by the above embodiments, or equivalent substitutions may be made on partial technical features; moreover, these modifications or substitutions will not make the essential of corresponding technical solutions depart from the spirit and scope of the technical solutions in respective embodiments of the present disclosure.

What is claimed is:

1. A multimedia data sending method based on a mobile terminal, characterized in that the mobile terminal at least comprises a MHL interface, a WiHD linkage unit and a Miracast linkage unit; comprising:
when detecting a trigger operation of a user for multimedia data currently displayed by the mobile terminal, deciding a target linkage unit from the MHL interface and/or the WiHD linkage unit and/or the Miracast linkage unit;
sending the multimedia data to a display device by employing the target linkage unit, wherein the display device is configured to display the multimedia data.

2. The method according to claim 1, wherein the step of, when detecting a trigger operation of a user for multimedia data currently displayed by the mobile terminal, deciding a target linkage unit from the MHL interface and/or the WiHD linkage unit and/or the Miracast linkage unit comprises:
when detecting a trigger operation of a user for multimedia data currently displayed by the mobile terminal, respectively acquiring decision parameter information corresponding to the MHL interface, the WiHD linkage unit and the Miracast linkage unit;
deciding a target linkage unit from the MHL interface, the WiHD linkage unit or the Miracast linkage unit in accordance with the decision parameter information.

3. The method according to claim 2, wherein the decision parameter information at least comprises bandwidth and transmission rate parameters, a delay parameter, a power consumption parameter, a safety parameter, a quality parameter of the multimedia data, a flow performance and a signal stability of WIFI under a prevailing circumstance.

4. The method according to claim 3, wherein the step of deciding a target linkage unit from the MHL interface, the WiHD linkage unit or the Miracast linkage unit in accordance with the decision parameter information comprises:
when detecting a trigger operation of a user for multimedia data currently displayed by the mobile terminal, determining whether an access device accesses to the MHL interface or not;
if the access device accesses to the MHL interface, using the MHL interface as a target linkage unit;
if no access device accesses to the MHL interface, determining whether a quality parameter of the multimedia data is smaller than a first preset threshold or not and a signal intensity of the WiHD linkage unit is greater than a second preset threshold or not;
if the quality parameter of the multimedia data is greater than the first preset threshold and the signal intensity of the WiHD linkage unit is greater than the second preset threshold, using the WiHD linkage unit as the target linkage unit;
if the quality parameter of the multimedia data is smaller than the first preset threshold and the signal intensity of the WiHD linkage unit is smaller than the second preset threshold, using the Miracast linkage unit as the target linkage unit.

5. The method according to claim 1, wherein the step of sending the multimedia data to a display device by employing the target linkage unit comprises:
establishing a linkage channel between the mobile terminal and the display device by employing the target linkage unit;
acquiring multimedia data the picture source quality of which adapts to the target linkage unit;
sending the adapted multimedia data to the display device through the linkage channel.

6. A mobile terminal for sending multimedia data, wherein the mobile terminal at least comprises a MHL interface, a WiHD linkage unit and a Miracast linkage unit; the mobile terminal further comprises:
at least one processor; and
a memory communicably connected with the at least one processor for storing instructions executable by the at least one processor, wherein execution of the instructions by the at least one processor causes the at least one processor to:
when detecting a trigger operation of a user for multimedia data currently displayed by the mobile terminal, decide a target linkage unit from the MHL interface and/or the WiHD linkage unit and/or the Miracast linkage unit;
send the multimedia data to a display device by employing the target linkage unit, wherein the display device is configured to display the multimedia data.

7. The mobile terminal according to claim 6, wherein when detecting a trigger operation of a user for multimedia data currently displayed by the mobile terminal, decide a target linkage unit from the MHL interface and/or the WiHD linkage unit and/or the Miracast linkage unit comprises:
when detecting a trigger operation of a user for multimedia data currently displayed by the mobile terminal, respectively acquiring decision parameter information corresponding to the MHL interface, the WiHD linkage unit or the Miracast linkage unit;
deciding a target linkage unit from the MHL interface, the WiHD linkage unit or the Miracast linkage unit in accordance with the decision parameter information.

8. The mobile terminal according to claim 7, wherein the decision parameter information at least comprises bandwidth and transmission rate parameters, a delay parameter, a power consumption parameter, a safety parameter, a quality parameter of the multimedia data, a flow performance and a signal stability of WIFI under a prevailing circumstance.

9. The mobile terminal according to claim 8, wherein deciding a target linkage unit from the MHL interface, the WiHD linkage unit or the Miracast linkage unit in accordance with the decision parameter information comprises:
when detecting a trigger operation of a user for multimedia data currently displayed by the mobile terminal, determining whether an access device accesses to the MHL interface or not;
if the access device accesses to the MHL interface, using the MHL interface as a target linkage unit;
if no access device accesses to the MHL interface, determining whether a quality parameter of the multimedia data is smaller than a first preset threshold or not and a signal intensity of the WiHD linkage unit is greater than a second preset threshold or not;
if the quality parameter of the multimedia data is greater than the first preset threshold and the signal intensity of the WiHD linkage unit is greater than the second preset threshold, using the WiHD linkage unit as the target linkage unit;
if the quality parameter of the multimedia data is smaller than the first preset threshold and the signal intensity of the WiHD linkage unit is smaller than the second preset threshold, using the Miracast linkage unit as the target linkage unit.

10. The mobile terminal according to claim 5, wherein send the multimedia data to a display device by employing the target linkage unit, wherein the display device is configured to display the multimedia data comprises:
establishing a linkage channel between the mobile terminal and the display device by employing the target linkage unit;
acquiring multimedia data the picture source quality of which adapts to the target linkage unit;
sending the adapted multimedia data to the display device through the linkage channel.

11. A non-transitory computer readable medium, storing executable instructions that, when executed by a mobile terminal, cause the mobile terminal to:
when detecting a trigger operation of a user for multimedia data currently displayed by the mobile terminal, decide a target linkage unit from the MHL interface and/or the WiHD linkage unit and/or the Miracast linkage unit;
send the multimedia data to a display device by employing the target linkage unit, wherein the display device is configured to display the multimedia data.

12. The non-transitory computer readable medium according to claim 11, wherein when detecting a trigger operation of a user for multimedia data currently displayed by the mobile terminal, decide a target linkage unit from the MHL interface and/or the WiHD linkage unit and/or the Miracast linkage unit comprises:
when detecting a trigger operation of a user for multimedia data currently displayed by the mobile terminal, respectively acquiring decision parameter information corresponding to the MHL interface, the WiHD linkage unit or the Miracast linkage unit;
deciding a target linkage unit from the MHL interface, the WiHD linkage unit or the Miracast linkage unit in accordance with the decision parameter information.

13. The non-transitory computer readable medium according to claim 12, wherein the decision parameter information at least comprises bandwidth and transmission rate parameters, a delay parameter, a power consumption parameter, a safety parameter, a quality parameter of the multimedia data, a flow performance and a signal stability of WIFI under a prevailing circumstance.

14. The non-transitory computer readable medium according to claim 13, wherein deciding a target linkage unit from the MHL interface, the WiHD linkage unit or the Miracast linkage unit in accordance with the decision parameter information comprises:
when detecting a trigger operation of a user for multimedia data currently displayed by the mobile terminal, determining whether an access device accesses to the MHL interface or not;
if the access device accesses to the MHL interface, using the MHL interface as a target linkage unit;
if no access device accesses to the MHL interface, determining whether a quality parameter of the multimedia data is smaller than a first preset threshold or not and a signal intensity of the WiHD linkage unit is greater than a second preset threshold or not;
if the quality parameter of the multimedia data is greater than the first preset threshold and the signal intensity of the WiHD linkage unit is greater than the second preset threshold, using the WiHD linkage unit as the target linkage unit;
if the quality parameter of the multimedia data is smaller than the first preset threshold and the signal intensity of the WiHD linkage unit is smaller than the second preset threshold, using the Miracast linkage unit as the target linkage unit.

15. The non-transitory computer readable medium according to claim 11, wherein send the multimedia data to a display device by employing the target linkage unit, wherein the display device is configured to display the multimedia data comprises:
establishing a linkage channel between the mobile terminal and the display device by employing the target linkage unit;
acquiring multimedia data the picture source quality of which adapts to the target linkage unit;
sending the adapted multimedia data to the display device through the linkage channel.
